(19) United States
(12) Patent Application Publication
(10) Pub. No.: US 2011/0097686 A1
(43) Pub. Date: Apr. 28, 2011

(54) GINGIVAL RETRACTION SYSTEM

(76) Inventor: Don ROSS, Atlanta, GA (US)

(21) Appl. No.: 12/914,399

(22) Filed: Oct. 28, 2010

Related U.S. Application Data
(60) Provisional application No. 61/255,612, filed on Oct. 28, 2009.

(51) Int. Cl. A61C 5/14

(52) U.S. Cl. 433/138; 433/215

(57) ABSTRACT

A gingival retraction system for retracting gingival tissue surrounding a selected tooth within the mouth of a subject is disclosed. In one aspect, the gingival retraction system has a gingival retraction cord and a handle. The gingival retraction cord has at least one lead portion and at least one retraction portion. Portions of the gingival retraction cord are positioned within the gingival sulcus surrounding the selected tooth. The handle can be used to tighten and shorten the portion of the gingival retraction cord positioned within the gingival sulcus surrounding the selected tooth.

### CROSS-REFERENCE TO RELATED APPLICATION

This application claims the benefit of priority to U.S. Provisional Patent Application Ser. No. 61/255,612, filed Oct. 28, 2009, the entire disclosure of which is incorporated by reference herein for all purposes.

### FIELD OF THE INVENTION

This invention relates to a system and method for retracting gingival tissue within the mouth of a subject. More specifically, this invention relates to a system and method for retracting gingival tissue surrounding a tooth of a subject prior to initiating a tooth preparation procedure as part of a dental restoration.

### BACKGROUND OF THE INVENTION

In dental therapeutics, a damaged tooth is prepared for receiving an artificial crown or onlay or inlay or other dental restoration by removal of portions of the tooth with a high-speed drill or other instrument. The junction where the uncut, more apical portion of the tooth meets the cut, more coronal portion of the tooth is commonly referred to as the “margin” of the tooth. An artificial crown is fabricated based on an impression of the tooth, including the margin of the tooth, the gingival tissue surrounding the tooth, and the area between the tooth and the gingival tissue surrounding the tooth (“the gingival sulcus” or “gingival crevice”). Thus, the impression of the margins of the tooth must be sufficiently detailed to allow for proper fabrication of an artificial crown.

A gingival retraction cord is commonly used to separate gingival tissue surrounding a tooth from the tooth and to create additional space for accurately recording an impression of the margins of the tooth. In addition, a gingival retraction cord is commonly used to keep bleeding and seepage of sulcular fluid away from the margin during the impression by applying pressure to the tissue and absorbing blood and sulcular fluid. Typically, a gingival retraction cord is placed into the gingival sulcus surrounding a tooth. In common tooth preparation procedures, the tooth is prepared by removing portions of the tooth until the margins of the tooth are formed. During the tooth preparation procedure, dental instruments can contact gingival tissue, causing damage and bleeding. Following preparation of the tooth, a gingival retraction cord is placed into the gingival crevice, at which point the impression of the tooth can be completed.

Due to the thicknesses of known gingival retraction cords, it is difficult to position retraction cords through the spaces between adjacent teeth from the occlusal toward the gingiva, through the “contact area” defined by adjacent teeth, and then within the gingival sulcus. Thus, it is often challenging to place known gingival retraction cords before preparation of a tooth has begun. Before preparing the margin, it can be difficult and time-consuming to horizontally direct a retraction cord into the gingival sulcus, and this can subject the gingival tissue to trauma. In some cases, the position of the gingiva can be so close to the tooth surface and tooth margin area that preparation of the margin before placement of the cord risks contacting the gingiva with preparation instruments, which can cause gingival damage and bleeding. Additionally, during placement of known retraction cords when the margin is fully or partially prepared, the retraction cord can hang up on edges formed by the tooth margin, especially at the line angles (corners) of the tooth preparation.

Known gingival retraction cords commonly have a uniform thickness and a consistent material composition. Due to the uniform thicknesses of many known gingival retraction cords, the cords are often inadequately sized to be both easily positioned through the contact area between the teeth and to effectively retract the gingiva around the gingival sulcus. If a gingival retraction cord is thick enough to retract the gingiva, it is often too thick to slide through the contact area between the teeth. Similarly, if a gingival retraction cord is thin enough to slide through the contact area, it is often too thin to effectively retract gingival tissue. Moreover, during placement of known gingival retraction cords after a tooth margin has been fully or partially prepared, the material of the gingival retraction cords often have a tendency to become caught after contacting the margins of the tooth. Further, positioning of known gingival retraction cords frequently requires a dental practitioner to use many repetitive steps or poking movements with a cord packing instrument that are time consuming and can cause injury or bleeding in the gingiva surrounding the tooth. Cutting the proper length of cord and securing the ends in the gingival sulcus can also be time-consuming and can injure the gingiva. Trimming excess portions of gingival retraction cords can cause unnecessary delays in the time required to secure the gingival retraction cord within the gingival sulcus.

Thus, there is a need in the pertinent art for a system for gently and securely positioning gingival retraction cords within the gingival sulcus in an efficient manner prior to initiation of a tooth preparation procedure. Additionally, there is a need in the pertinent art for a system for positioning gingival retraction cords having appropriate thicknesses and resiliency for both sliding through the contact area between adjacent teeth and into the gingival sulcus and retracting gingival tissue. Further, there is a need in the pertinent art for a system that permits dental practitioners to accurately position and trim gingival retraction cords with improved efficiency.

### SUMMARY

The invention relates to a gingival retraction system for retracting gingival tissue surrounding a damaged tooth within the mouth of a subject. In one embodiment, the gingival retraction system has a gingival retraction cord and a handle.

In one aspect, the gingival retraction cord has a first lead portion and a second lead portion that are configured to enter into and pass through the contact areas between the damaged tooth and adjacent teeth in the mouth of the subject. In another aspect, the gingival retraction cord has a retraction portion configured for insertion within the gingival sulcus surrounding the damaged tooth. In an additional aspect, the retraction portion is attached between the first lead portion and the second lead portion.

In another aspect, the first lead portion and the second lead portion are made from conventional dental floss materials. In a further aspect, the retraction portion is made from at least one filament of material that is commonly used to manufacture gingival retraction cords. In one aspect, the retraction portion is impregnated with a retraction agent.

In an additional aspect, the handle of the gingival retraction system is attached to the first lead portion and the second lead portion. In another aspect, the handle is configured for selective movement by a dental practitioner until the retraction portion is securely positioned within the gingival sulcus proximate the damaged tooth. In a further aspect, the handle has a cutting mechanism for trimming portions of the gingival retraction cord that are not required to secure the retraction portion within the gingival sulcus. In still a further aspect, the handle can be reusable. Alternatively, the handle can be disposable.

### DETAILED DESCRIPTION OF THE FIGURES

These and other features of the preferred embodiments of the invention will become more apparent in the detailed description in which reference is made to the appended drawings wherein:

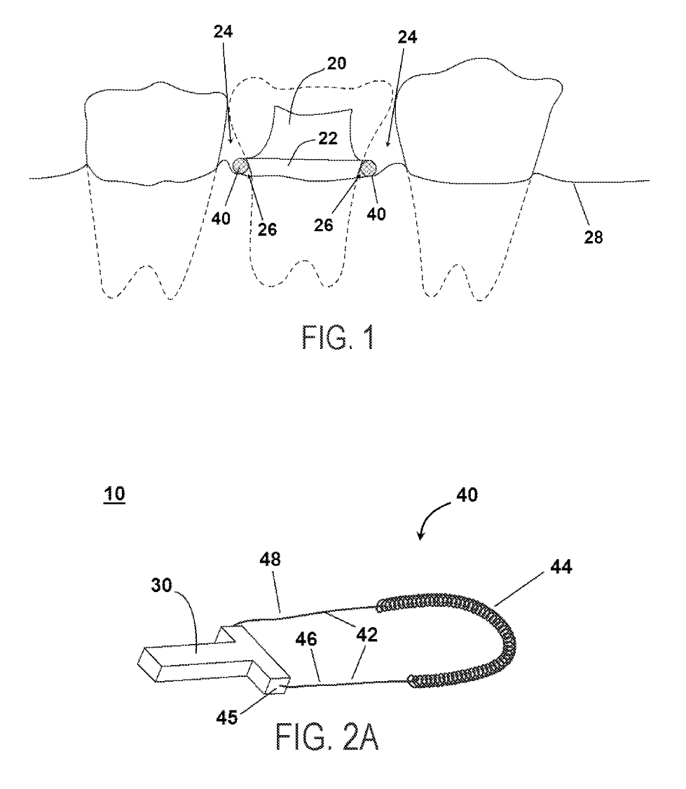

FIG. 1 depicts a side cross-sectional view of a gingival retraction cord positioned within the gingival sulcus surrounding a selected tooth, as described herein.

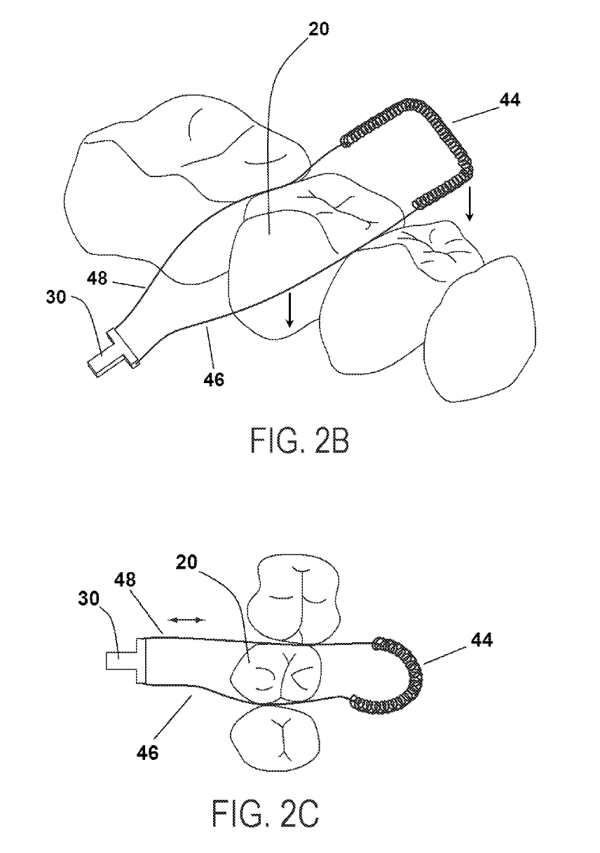

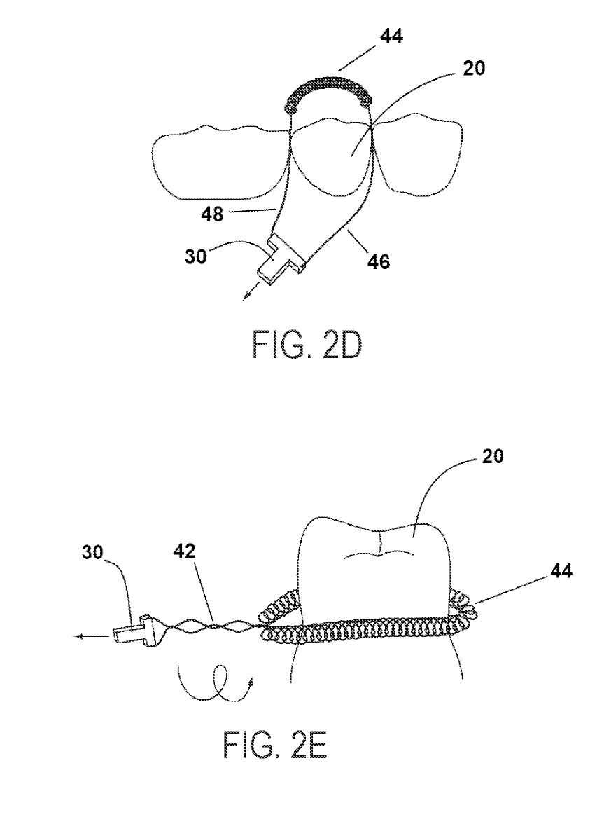

FIG. 2A depicts a side perspective view of one exemplary embodiment of a gingival retraction system, as described herein. FIG. 2B is a perspective view of the gingival retraction system of FIG. 2A immediately prior to positioning of the lead portions of the gingival retraction cord within the contact areas between the selected tooth and its adjacent teeth. FIG. 2C is an elevational view of the gingival retraction system of FIG. 2A after positioning of the lead portions of the gingival retraction cord within the contact areas between the selected tooth and its adjacent teeth. FIG. 2D is a side perspective view of the gingival retraction system of FIG. 2A after positioning of the lead portions of the gingival retraction cord within the contact areas between the selected tooth and its adjacent teeth. FIG. 2E is an isolated back perspective view of the gingival retraction system of FIG. 2A after the handle of the gingival retraction system has been moved to position the retraction portion of the gingival retraction cord around the selected tooth.

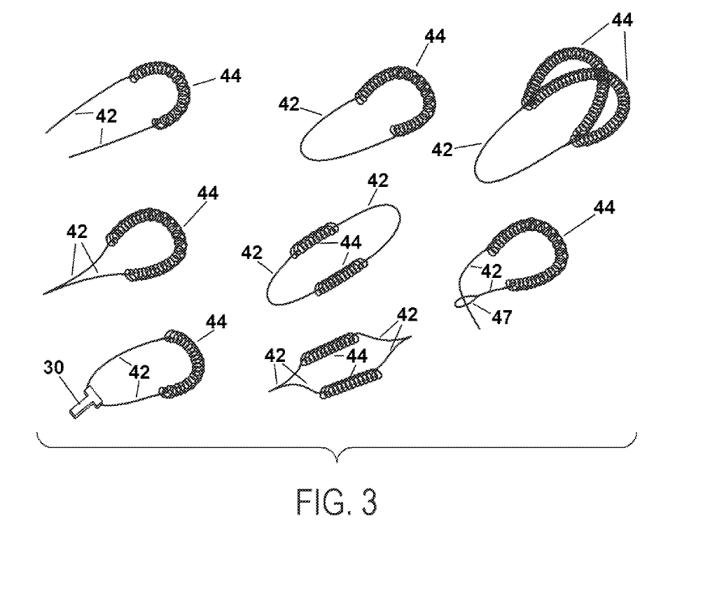

FIG. 3 depicts perspective views of exemplary gingival retraction cords, as described herein.

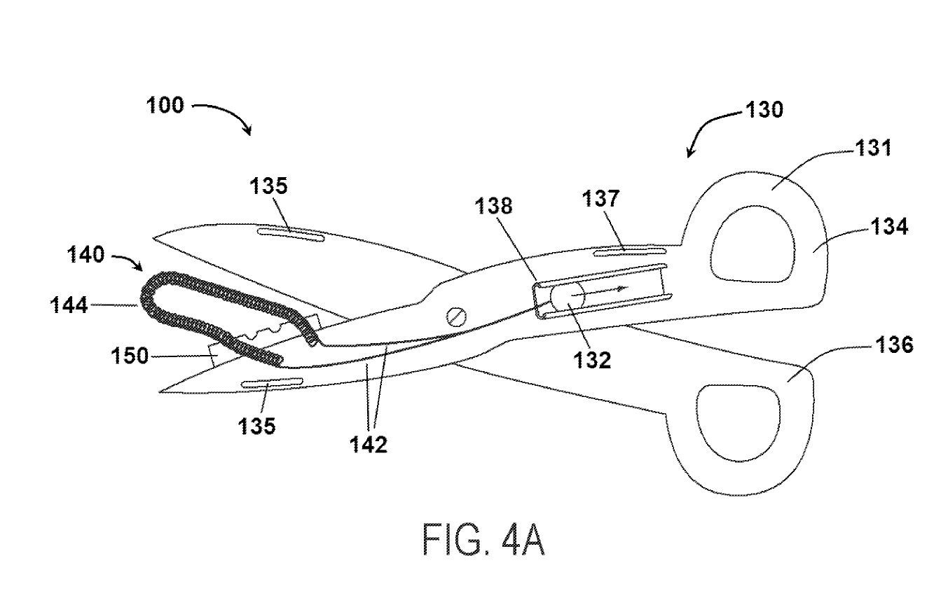

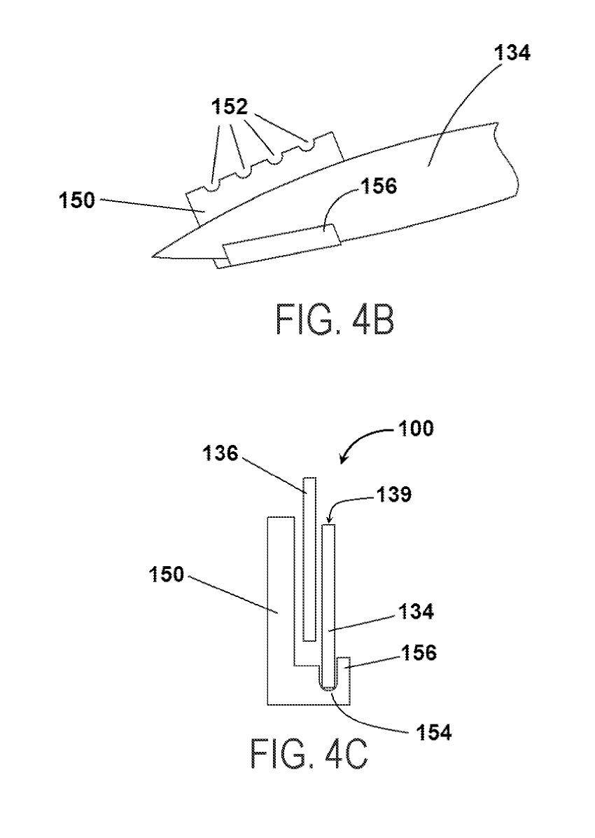

FIG. 4A depicts a side perspective view of an exemplary gingival retraction system comprising a gingival retraction cord and scissors, as described herein. FIG. 4B depicts an isolated side perspective view of the connection between a guide member and an outer blade of the scissors of the gingival retraction system of FIG. 4A. FIG. 4C is a front perspective view of the gingival retraction system of FIG. 4A.

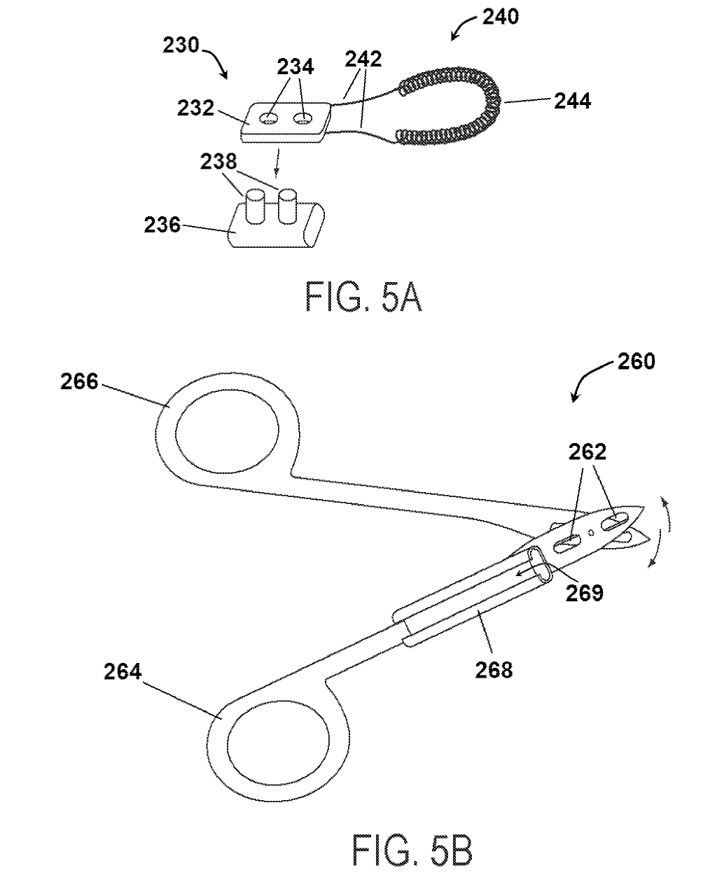

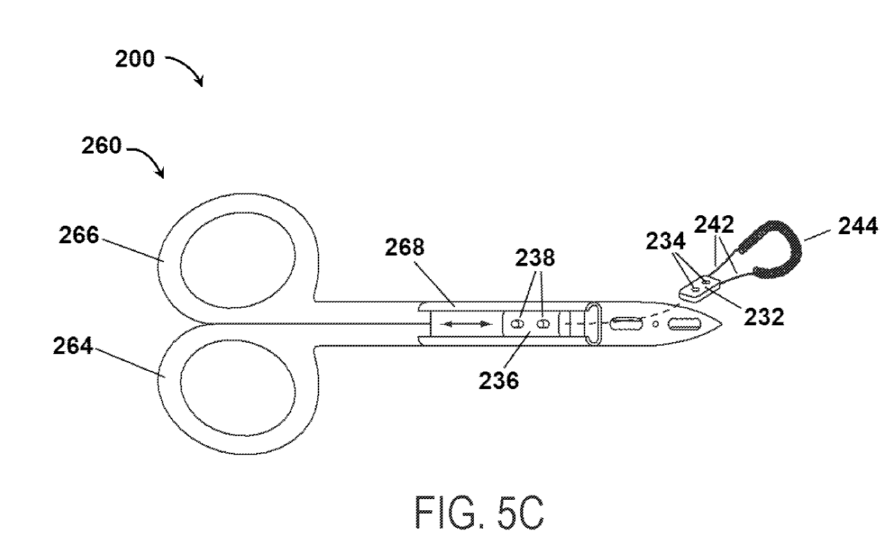

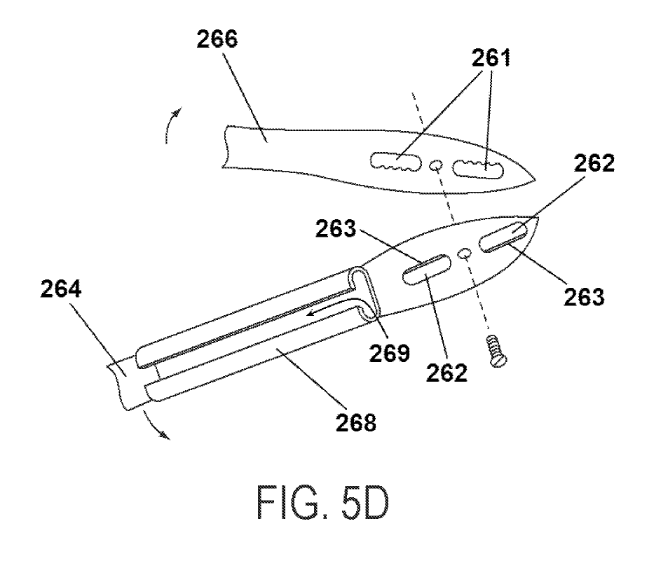

FIG. 5A depicts a side perspective view of a gingival retraction cord and a handle prior to mounting of the handle on a sliding member, as described herein. FIG. 5B depicts a side perspective view of scissors having a groove for receiving the sliding member of FIG. 5A, the scissors being shown in an open position, as described herein. FIG. 5C depicts a side perspective view of an exemplary gingival retraction system including the gingival retraction cord and handle of FIG. 5A and the scissors and groove of FIG. 5B, the scissors being shown in a closed position, as described herein. FIG. 5D is an exploded side perspective view of the blade members of the scissors of the gingival retraction system of FIG. 5C.

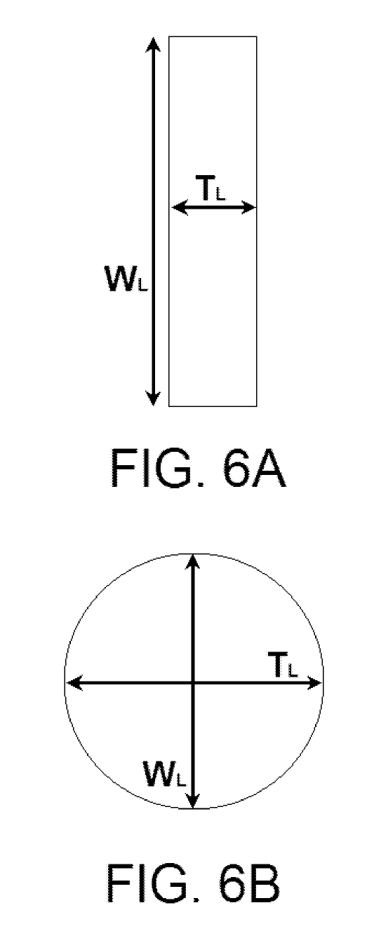

FIGS. 6A and 6B depict side cross-sectional views of the lead portions of exemplary gingival retraction cords, as described herein.

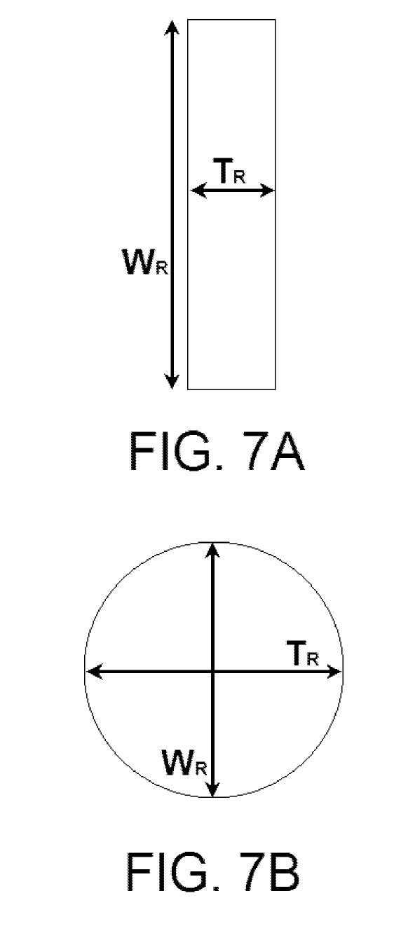

FIGS. 7A and 7B depict side cross-sectional views of the retraction portions of exemplary gingival retraction cords, as described herein.

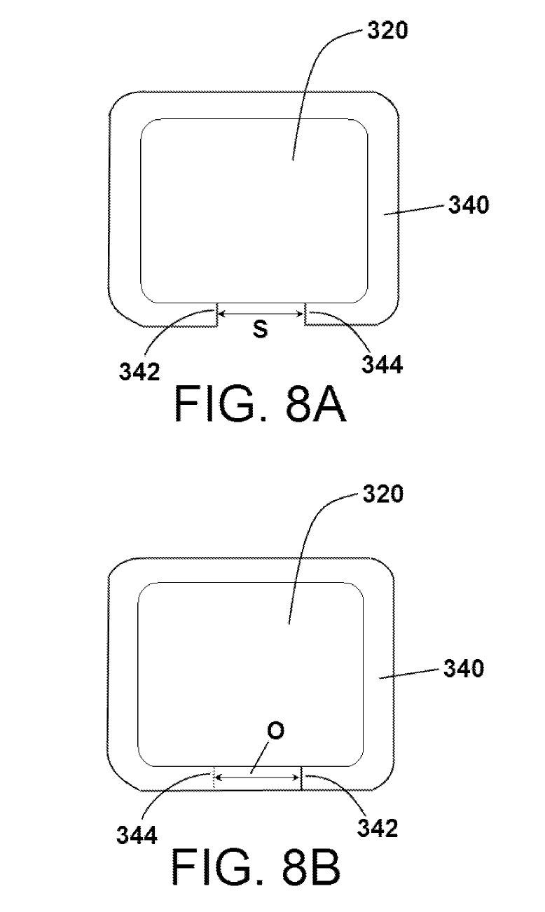

FIGS. 8A and 8B are elevational views depicting the positioning of retraction cords within portions of the gingival sulcus surrounding a selected tooth, as described herein.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a handle” can include two or more such handles unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

In one embodiment, the invention relates to a gingival retraction system for retracting gingival tissue proximate a selected tooth among a plurality of teeth within the mouth of a subject. It is contemplated that the selected tooth can have a perimeter. As depicted in FIG. 1, the solid lines of the selected tooth 20 correspond to the shape of the selected tooth, including tooth margins 22, following the performance of a tooth preparation procedure on the selected tooth. The dashed lines above the gingival tissue 28 correspond to the shape of the selected tooth 20 prior to performance of the tooth preparation procedure. Contact areas 24 are defined by the selected tooth 20 and adjacent teeth within the mouth of the subject. It is contemplated that the gingival retraction system can permit retraction of the gingival sulcus 26 surrounding at least a portion of the selected tooth 20 prior to initiation of a tooth preparation procedure on the selected tooth. The gingival sulcus 26 can be defined by at least a portion of the selected tooth 20 and at least a portion of displaced gingival tissue 28 proximate the selected tooth. It is further contemplated that the gingival retraction system can create adequate space for dental practitioners to accurately record the margins 22 of the selected tooth 20 during a tooth preparation and impression procedure. In addition, the gingival retraction system can protect the gingival tissue 28 of the mouth of the subject from injury by dental instruments during the preparation of the selected tooth 20. Further, the gingival retraction system can be configured to absorb blood or other fluids proximate the selected tooth 20. In one aspect, the gingival retraction system can comprise a gingival retraction cord 40 and a handle. In this aspect, and as shown in FIG. 1, the gingival retraction cord 40 can be positioned within the gingival sulcus 26 proximate the selected tooth 20.

In one aspect, and with reference to FIGS. 2A-3, the gingival retraction cord 40 of the gingival retraction system 10 can comprise at least one lead portion 42. In this aspect, and as shown in FIGS. 1 and 2B, the at least one lead portion 42 can be configured for movement in an apical direction to enter into contact areas 24 defined by the selected tooth 20 and adjacent teeth within the mouth of the subject. It is contemplated that movement of the at least one lead portion 42 in the apical direction can correspond to movement of the at least one lead portion 42 from a point proximate an occlusal surface (biting surface) of the selected tooth 20 toward the gingival tissue 28 surrounding the selected tooth. In one exemplary aspect, the at least one lead portion 42 can be moved in the apical direction to substantially concurrently enter into both contact areas 24 adjacent to the selected tooth 20. Thus, in this aspect, the entry of a first lead portion into a first contact area adjacent to the selected tooth can occur substantially concurrently with the entry of a second lead portion into a second contact area adjacent to the selected tooth. As shown in FIG. 2C, following entry of the at least one lead portion 42 into a contact surface, it is contemplated that the at least one lead portion 42 can be configured for movement toward the tongue of the subject or toward the cheeks or lips of the subject.

In another aspect, and as shown in FIGS. 2A-3, the gingival retraction cord 40 can comprise at least one retraction portion 44 configured for insertion within the gingival sulcus 26 surrounding at least a portion of the selected tooth 20. It is contemplated that the gingival sulcus 26 can substantially completely surround the perimeter of the selected tooth 20. Accordingly, as further described with reference to FIGS. 8A and 8B, it is contemplated that the gingival retraction cord 40 can be configured to substantially surround the selected tooth 20. In an additional aspect, each retraction portion 44 of the at least one retraction portion can be attached to a lead portion 42 of the at least one lead portion. With reference to FIGS. 1-2E, it is contemplated that the at least one lead portion 42 can be selectively moved within and through the contact areas 24 until the at least one retraction portion 44 is positioned proximate the gingival sulcus 26 surrounding the selected tooth 20.

As shown in FIG. 3, in an additional aspect, it is contemplated that the at least one lead portion 42 and the at least one retraction portion 44 can be attached to one another such that a loop of continuous material is formed. In this aspect, it is contemplated that portions of the gingival retraction cord 40 can be tied together to form the loop of continuous material. In another aspect, it is contemplated that at least one binder material can be used to attach the at least one lead portion 42 and the at least one retraction portion 44 to one another. In this aspect, the at least one binder material can comprise, for example and without limitation, glue, gum, or other binders known in the art. In a further aspect, the lead portions 42 of the at least one lead portion can be constructed of unitary material which passes through hollow core defined in the retraction portions 44 of the at least one retraction portion.

In one exemplary aspect, and with reference to FIGS. 2A-3, the at least one retraction portion 44 can comprise a single retraction portion. In this aspect, each lead portion 42 of the at least one lead portion can have a first end and a second end, and the retraction portion can be attached to at least one of the first end and the second end of each lead portion of the at least one lead portion. In another aspect, as shown in FIG. 2A, the at least one lead portion can comprise a first lead portion 46 and a second lead portion 48. In this aspect, it is contemplated that the retraction portion 44 can be attached to, and positioned between, the first lead portion 46 and the second lead portion 48. Alternatively, the first lead portion 46 and the second lead portion 48 can be constructed of unitary material which passes through a hollow core in the retraction portion 44. In one aspect, it is contemplated that the first lead portion 46, the retraction portion 44, and the second lead portion 48 can be attached to one another such that a loop of continuous material is formed. In this aspect, it is contemplated that portions of the gingival retraction cord 40 can be tied together to form the loop of continuous material. In another aspect, it is contemplated that at least one binder material can be used to attach the first lead portion 46 and the second lead portion 48 to the retraction portion 44 and/or the first lead portion 46 to the second lead portion 48. In this aspect, the at least one binder material can comprise, for example and without limitation, glue, gum, or other binders known in the art.

As shown in FIG. 3, in a further aspect, the gingival retraction cord 40 can comprise at least two lead portions 42 and at least two retraction portions 44. Optionally, in this aspect, the lead portions 42 and the retraction portions 44 can be secured to one another in an alternating fashion such that retraction portions are positioned between successive lead portions and lead portions are positioned between successive retraction portions.

In another aspect, the at least one lead portion 42 can comprise conventional dental floss and dental tape materials, including, for example and without limitation, nylon, polyester, polypropylene, expanded polytetrafluouroethylene, aromatic polyamide filaments, metal, and the like. However, it is contemplated that the at least one lead portion 42 can comprise any flexible and smooth material that is sized for passage through the contact areas 24 between adjacent teeth in the mouth of the subject. For example, and without limitation, it is contemplated that the at least one lead portion 42 can comprise materials used to make thread, filaments, ribbon, string, line, and the like. It is contemplated that flexible and smooth materials can easily be positioned and reciprocated within the contact areas 24 between adjacent teeth. In a further aspect, the gingival retraction cord 40 can be configured to split apart upon application of a predetermined amount of torque to a selected area along the length of the gingival retraction cord. In this aspect, it is contemplated that the gingival retraction cord 40 can be configured to split apart along a serrated portion of the gingival retraction cord.

In an additional aspect, the at least one lead portion 42 can comprise a substantially rigid portion. It is contemplated that the substantially rigid portion of the at least one lead portion 42 can be more easily held by conventional dental instruments or a handle, including handles such as those described herein. In another aspect, and as shown in FIG. 3, when the at least one lead portion 42 comprises a first lead portion 46 and a second lead portion 48, at least one of the first lead portion and the second lead portion can define a loop 47. It is contemplated that the loop 47 of one lead portion can be configured to receive the other lead portion. In this aspect, the first lead portion 46 can define the loop 47, and the second lead portion 48 can comprise a substantially rigid portion. Alternatively, the second lead portion can define the loop, and the first lead portion can comprise a substantially rigid portion. As one will appreciate, the substantially rigid portion of one lead portion can assist a dental practitioner in guiding that lead portion through a loop defined by another lead portion. As one will further appreciate, following the passage of one lead portion through the loop defined by another lead portion, the gingival retraction cord 40 can be selectively cinched down proximate the gingival margins 22 of the selected tooth.

In exemplary aspects, and with reference to FIGS. 6A-6B, each lead portion 42 of the at least one lead portion can have a maximum cross-sectional width W_{L} ranging from about 0.01 mm to about 0.20 mm. For example, and without limitation, the maximum cross-sectional width W_{L} of each lead portion 42 of the at least one lead portion can be 0.01 mm, 0.02 mm, 0.03 mm, 0.04 mm, 0.05 mm, 0.06 mm, 0.07 mm, 0.08 mm, 0.09 mm, 0.10 mm, 0.11 mm, 0.12 mm, 0.13 mm, 0.14 mm, 0.15 mm, 0.16 mm, 0.17 mm, 0.18 mm, 0.19 mm, 0.20 mm, and any lengths therebetween. However, it is contemplated that the maximum cross-sectional width W_{L} of each lead portion 42 can be any width that permits positioning and reciprocation of the at least one lead portion within the contact areas 24 and gingival sulcus 26 proximate the selected tooth 20. It is further contemplated that the smaller the maximum cross-sectional width W_{L} of each lead portion 42, the more easily each lead portion 42 can be positioned and reciprocated within the contact areas 24 and the gingival sulcus 26. In a further aspect, each lead portion 42 of the at least one lead portion can have a thickness T_{L} ranging from about 0.01 mm to about 0.20 mm, including, for example and without limitation, 0.01 mm, 0.02 mm, 0.03 mm, 0.04 mm, 0.05 mm, 0.06 mm, 0.07 mm, 0.08 mm, 0.09 mm, 0.10 mm, 0.11 mm, 0.12 mm, 0.13 mm, 0.14 mm, 0.15 mm, 0.16 mm, 0.17 mm, 0.18 mm, 0.19 mm, 0.20 mm, and any lengths therebetween. However, it is contemplated that the thickness T_{L} of each lead portion 42 can be any thickness that permits positioning and reciprocation of the at least one lead portion within the contact areas 24 and gingival sulcus 26 proximate the selected tooth 20. It is further contemplated that the smaller the maximum cross-sectional thickness T_{L} of each lead portion, the more easily each lead portion can be positioned and reciprocated within the contact areas and the gingival sulcus.

In one aspect, as shown in FIG. 6A, it is contemplated that each lead portion 42 can have a substantially rectangular cross-sectional shape having cross-sectional width W_{L} and cross-sectional thickness T_{L}. In another aspect, as shown in FIG. 6B, it is further contemplated that each lead portion 42 can have a substantially circular cross-sectional shape having cross-sectional width W_{L} and cross-sectional thickness T_{L}. In this aspect, it is contemplated that cross-section width W_{L} and cross-sectional thickness T_{L} can substantially correspond to the diameter of the cross-section of the lead portion 42 and, therefore, be substantially equal to one another. Although not shown in FIG. 6A or 6B, it is contemplated that each lead portion 42 can have any cross-sectional shape that permits movement of the gingival retraction cord 40 in a desired manner within the contact areas 24 and the gingival sulcus 26 surrounding the selected tooth 20 within the mouth of the subject.

In exemplary aspects, and with reference to FIGS. 7A-7B, each retraction portion 44 of the at least one retraction portion can have a maximum cross-sectional width W_{R} ranging from about 0.20 mm to about 3.00 mm. For example, and without limitation, the maximum cross-sectional width W_{R} of each retraction portion can be 0.20 mm, 0.30 mm, 0.40 mm, 0.50 mm, 0.60 mm, 0.70 mm, 0.80 mm, 0.90 mm, 1.00 mm, 1.10 mm, 1.20 mm, 1.30 mm, 1.40 mm, 1.50 mm, 1.60 mm, 1.70 mm, 1.80 mm, 1.90 mm, 2.00 mm, 2.10 mm, 2.20 mm, 2.30 mm, 2.40 mm, 2.50 mm, 2.60 mm, 2.70 mm, 2.80 mm, 2.90 mm, 3.00 mm, and any lengths therebetween. However, it is contemplated that the maximum cross-sectional width W_{R} of each retraction portion can be any width that permits secure positioning of the retraction portion within the gingival sulcus 26 proximate the selected tooth 20. In a further aspect, each retraction portion 44 of the gingival retraction cord 40 can have a maximum cross-sectional thickness T_{R} ranging from about 0.20 mm to about 3.00 mm, including, for example and without limitation, 0.20 mm, 0.30 mm, 0.40 mm, 0.50 mm, 0.60 mm, 0.70 mm, 0.80 mm, 0.90 mm, 1.00 mm, 1.10 mm, 1.20 mm, 1.30 mm, 1.40 mm, 1.50 mm, 1.60 mm, 1.70 mm, 1.80 mm, 1.90 mm, 2.00 mm, 2.10 mm, 2.20 mm, 2.30 mm, 2.40 mm, 2.50 mm, 2.60 mm, 2.70 mm, 2.80 mm, 2.90 mm, 3.00 mm, and any lengths therebetween. However, it is contemplated that the maximum cross-sectional thickness T_{R} of the retraction portion can be any cross-sectional thickness T_{R} that permits secure positioning of the retraction portion 44 within the gingival sulcus 26 proximate the selected tooth 20.

In one aspect, as shown in FIG. 7A, it is contemplated that each retraction portion 44 can have a substantially rectangular cross-sectional shape having cross-sectional width W_{R} and cross-sectional thickness T_{R}. In another aspect, as shown in FIG. 7B, it is further contemplated that each retraction portion 44 can have a substantially circular cross-sectional shape having cross-sectional width W_{R} and cross-sectional thickness T_{R}. In this aspect, it is contemplated that cross-section width W_{R} and cross-sectional thickness T_{R} can substantially correspond to the diameter of the cross-section of the retraction portion 44 and, therefore, be substantially equal to one another. Although not shown in FIG. 7A or 7B, it is contemplated that each retraction portion 44 can have any cross-sectional shape that permits secure positioning of the retraction portion within the gingival sulcus 26 surrounding the selected tooth 20 within the mouth of the subject.

In another aspect, each lead portion 42 of the at least one lead portion can have a longitudinal length. For example, and without limitation, the length of each lead portion 42 of the at least one lead portion can range from about 1 mm to about 40 mm. In a further aspect, each retraction portion 44 of the retraction portion can have a longitudinal length. For example, and without limitation, the length of each retraction portion 44 can range from about 3 mm to about 40 mm.

In an additional aspect, the gingival retraction cord 40 can comprise fluoride or fluoride-containing compounds as are commonly known in the art. In this aspect, it is contemplated that at least one lead portion 42 of the at least one lead portion can comprise fluoride or fluoride-containing compounds. It is further contemplated that at least one retraction portion 44 of the at least one retraction portion can comprise fluoride or fluoride-containing compounds. In another aspect, it is contemplated that at least one lead portion 42 of the at least one lead portion can comprise mediators, medicaments, or peroxide-producing compounds. It is further contemplated that at least one retraction portion 44 of the at least one retraction portion can comprise mediators, medicaments, or peroxide-producing compounds as are commonly known in the art. In a further aspect, the at least one lead portion 42 can be coated with one or more friction-resistant coatings, including, for example and without limitation, microcrystalline wax, polyvinyl alcohol, polyvinyl acetate, and the like. It is contemplated that the friction-resistant coatings can be applied by any means commonly known in the art, including, for example and without limitation, spraying, padding, and emulsion. In another aspect, the at least one lead portion 42 can comprise a metallic planar extension to assist a dental practitioner in grasping and/or positioning the gingival retraction cord 40.

In another aspect, each retraction portion 44 of the at least one retraction portion of the gingival retraction cord 40 can comprise at least one filament of at least one selected material. In one aspect, the at least one filament can comprise a single filament. In another aspect, each retraction portion 44 of the at least one retraction portion can comprise a plurality of filaments. In this aspect, the plurality of filaments can be positioned in a selected configuration relative to one another. It is contemplated that the selected configuration can be any commonly known configuration of cord, rope, and the like, including, for example and without limitation, a twisted, braided, or knitted configuration. In an additional aspect, each retraction portion 44 of the at least one retraction portion of the gingival retraction cord 40 can comprise foam-like material as is commonly known in the art. In a further aspect, each retraction portion 44 of the at least one retraction portion can comprise rubber-like material as is commonly known in the art. In still a further aspect, each retraction portion 44 of the at least one retraction portion can be substantially cylindrical.

In one aspect, the retraction portion 44 can comprise materials conventionally used to manufacture gingival retraction cords, including, for example and without limitation, nylon, polyester, cotton, and the like. It is contemplated that these materials can be substantially elastic and resilient and can substantially maintain their positions following insertion within the gingival sulcus 26. It is further contemplated that these elastic and resilient materials can resist splitting or fraying of the retraction portion 44 during use of the gingival retraction cord 40 within the mouth of the subject. In one aspect, it is contemplated that the at least one selected material can also comprise a metallic material, such as, without limitation, gold or copper wire, to provide additional stability to the retraction portion 44. In this aspect, the metallic material can be substantially malleable. Additionally, it is contemplated that the metallic material can be substantially structurally incorporated into at least one retraction portion 44 of the gingival retraction cord 40. In a further aspect, the at least one selected material can be fluid-absorbent. It is contemplated that fluid-absorbent materials can absorb moisture within the gingival sulcus and help improve the final resulting impression. It is still further contemplated that the at least one selected material can be substantially lint-free.

In an additional aspect, each retraction portion 44 of the at least one retraction portion of the gingival retraction cord 40 can be impregnated with at least one retraction agent. Alternatively, each retraction portion 44 can be soaked or otherwise treated with at least one retraction agent. In one aspect, it is contemplated that the at least one retraction agent can comprise one or more medicaments, including, without limitation, clotting agents, drying agents, hemostatic agents, and topical anesthetics. In this aspect, the at least one retraction agent can comprise an agent configured to promote the expansion and stability of the gingival sulcus 26, such as, for example and without limitation, ferric chloride, alum, aluminum chloride, aluminum potassium sulfate, and the like, as well as mixtures thereof. In another aspect, it is contemplated that the hemostatic agent can be, for example and without limitation, epinephrine, Vitamin K, calcium ions, blood factors, and the like. It is further contemplated that these hemostatic agents can reduce or prevent continued bleeding within the gingival sulcus 26.

Optionally, as shown in FIGS. 2A-3, the gingival retraction system 10 can comprise a handle 30. In one aspect, and with reference to FIG. 2A, the handle 30 of the gingival retraction system 10 can be attached to the at least one lead portion 42 at least one attachment point 45. In one aspect, when the at least one lead portion 42 comprises a first lead portion 46 and a second lead portion 48, the first lead portion can be attached to the handle at a first attachment point, and the second lead portion can be attached to the handle at a second attachment point. It is contemplated that the first attachment point and the second attachment point can be spaced from one another by a selected distance. In one aspect, the selected distance can be selectively adjustable by a dental practitioner. For example, and without limitation, the selected distance can be substantially equal to the width of the selected tooth. Alternatively, the handle 30 can be attached to a retraction portion 44 of the gingival retraction cord 40. Where the gingival retraction cord 40 comprises a single retraction portion 44, it is contemplated that the handle can be attached to a medial portion of the retraction portion. It is further contemplated that the gingival retraction system 10 can comprise a first handle attached to the at least one lead portion 42 and a second handle attached to a medial portion of the retraction portion 44.

In another aspect, the handle 30 of the gingival retraction system 10 can be selectively moveable by a dental practitioner within the mouth of the subject. In one aspect, the handle 30 can be configured for rotation. In another aspect, the handle 30 can be configured for sliding. However, it is contemplated that other movements of the handle 30 can be used to securely position the at least one retraction portion 44 within the gingival sulcus 26 surrounding the selected tooth 20 of the subject. In one aspect, the at least one attachment point 45 can be positioned such that, upon rotation, sliding, or other movement of the handle 30, the gingival retraction cord 40 will be tightened or cinched around the selected tooth 20 apical to the tooth margin 22. In this aspect, it is contemplated that the gingival retraction cord 40 can be twisted onto itself to tighten the cord around the selected tooth 20. It is further contemplated that the handle 30 of the gingival retraction system 10 can be selectively rotated, slid, or otherwise moved until the retraction portion 44 is securely positioned within the gingival sulcus 26 substantially entirely around the selected tooth 20.

In some aspects, the handle 30 can be a single-part handle. In these aspects, it is contemplated that the handle 30 can be any type of handle commonly used in medical instruments. For example, and without limitation, the handle can be a substantially elongate handle. In one aspect, the handle can be a substantially elongate cylindrical handle. In another aspect, the handle can be a substantially elongate rectangular handle. However, it is contemplated that any handle that permits positioning and movement of the gingival retraction cord proximate the selected tooth can be used. In one exemplary aspect, as shown in FIGS. 2A-3, the handle can be substantially T-shaped. In this aspect, it is contemplated that the at least one attachment point 45 can be positioned along a top portion of the handle 30. It is further contemplated that the handle 30 can comprise a grip portion that is ergonomically configured for placement within the hand of a dental practitioner. However, it is still further contemplated that the handle 30 can be shaped in any manner that permits use of the handle within the mouth of the subject between the selected tooth 20 and the cheeks or lips of the subject or between the selected tooth and the palate or tongue. It is further contemplated that the handle 30 can be shaped to permit use of the handle within the mouth of the subject between both the selected tooth 20 and the cheeks of the subject and between the selected tooth and the palate or tongue. For example, and without limitation, the handle 30 can be substantially triangular, rectangular, circular, cylindrical, and the like, or a combination thereof. In one exemplary aspect, the thickness of the handle 30 can be minimized to reduce the likelihood of undesired contact between the handle and other objects within the surgical field.

In other aspects, the handle 30 can be a multi-part handle. For example, the handle 30 can comprise two or more parts that cooperate to function as a handle of a gingival retraction system 10, as described herein. It is contemplated that the different components of the disclosed multi-part handles can be detachable from one another. Alternatively, the different components of the disclosed multi-part handles can be integrally connected.

In a further aspect, the handle 30 of the gingival retraction system 10 can comprise a tightening mechanism for moving the gingival retraction cord 40 in one or more directions such that the retraction portion 44 of the cord is tightened or cinched around at least a portion of the selected tooth 20. In one aspect, the tightening mechanism can comprise, for example and without limitation, a one-way pull device, a one-way push device, a multi-directional pull device, a multi-directional push device, calipers, twisters, sliders, fanning devices, and the like. In an additional aspect, the tightening mechanism can comprise at least one interior bore for receiving the gingival retraction cord 40. In this aspect, the handle 30 can comprise means for securing the tightening mechanism in a desired position, wherein, in the desired position, portions of the gingival retraction cord 40 that have passed through the at least one interior bore of the tightening mechanism are securely positioned away from the selected tooth 20. In this aspect, the tightening mechanism can be moved toward the selected tooth 20 to shorten the length of the retraction portion 44 that fills the gingival sulcus 26 and extends around the selected tooth 20. It is contemplated that the tightening mechanism can be activated by manual, magnetic, electrical, or mechanical means. For example, and without limitation, the tightening mechanism can be activated by a mechanical spring.

In still a further aspect, the handle 30 of the gingival retraction system can comprise constricting means for squeezing together the portions of the gingival retraction cord 40 that are not positioned within the gingival sulcus 26. It is contemplated that the constricting means can be used to further tighten the retraction portion 44 around the selected tooth 20.

Optionally, the handle 30 of the gingival retraction system 10 can comprise cutting means for trimming portions of the gingival retraction cord 40 that are not required to secure the retraction portion 44 within the gingival sulcus 26. It is contemplated that the cutting means can be any mechanism for cutting filament materials commonly known in the art, such as, for example and without limitation, a guillotine, detent, scissor, razor, and the like. However, it is contemplated that other known means for cutting materials can be used to cut the gingival retraction cord 40 as described herein. It is further contemplated that the cutting means can comprise any material of sufficient sharpness and rigidity to completely cut the gingival retraction cord 40 within the mouth of the subject. For example, it is contemplated that the cutting means can comprise metallic materials. It if further contemplated that the cutting means can be coupled to a tightening mechanism or constricting means as described herein to allow for more efficient cutting of the gingival retraction cord 40. In one aspect, the cutting means can be angled from the handle 30 to permit access to malpositioned teeth.

In exemplary aspects, and with reference to FIGS. 4A-5D, the handle can be a multi-part handle comprising scissors as are commonly known in the art. As shown in FIGS. 4A-4C, gingival retraction system 100 comprises a gingival retraction cord 140 having at least one lead portion 142 and at least one retraction portion 144, as described with reference to FIGS. 2A-3 and the corresponding description. Gingival retraction system 100 further comprises a handle 130. The handle 130 comprises scissors 131 and sliding member 132. It is contemplated that the sliding member 132 of the handle 130 can be attached to the gingival retraction cord 140, as described herein with respect to handle 30 and gingival retraction cord 40.

In one aspect, as shown in FIGS. 4A-4C, the scissors 131 can comprise a first blade member 134 and a second blade member 136 pivotally connected to the first blade member. It is contemplated that the first blade member 134 and the second blade member 136 can be configured to cut the gingival retraction cord 140. In one optional aspect, a guide member 150 having a plurality of notches 152 can be detachably secured thereto at least one of the two blade members 134, 136 of the scissors 131. In this aspect, each notch 152 of the plurality of notches can be configured to receive and secure the gingival retraction cord 140 in a desired position prior to cutting of the gingival retraction cord by the blade members 134, 136. In this aspect, it is contemplated that at least one blade member 134, 136 can comprise a grooved portion 135 configured to receive an engagement portion 156 of the guide member 150 such that the guide member is secured in an operative position. In one aspect, the guide member 150 can define a cavity 154 for receipt of at least one blade member. In this aspect, it is contemplated that, when the guide member 150 is secured in the operative position, the blade member to which the guide member is secured (134, as shown in FIGS. 4A-4C) can be positioned within the cavity 154 of the guide member. It is further contemplated that, when the guide member 150 is secured in the operative position, the blade member to which the guide member is secured (134, as shown in FIGS. 4A-4C) can be spaced from the plurality of notches 152 to thereby define a gap for receipt of the other blade member of the scissors. It is still further contemplated that, when the guide member 150 is secured in the operative position, the plurality of notches 152 can be positioned above a top edge 139 of the blade member to which the guide member is secured (134, as shown in FIGS. 4A-4C).

In one aspect, it is contemplated that, when the guide member 150 is secured in the operative position, the plurality of notches 152 can be used by a dental practitioner to ensure that the gingival retraction cord 140 is cut in appropriate locations. In a further aspect, the scissors 131 can comprise storage means for attaching the guide member to the scissors during periods of non-use. For example and without limitation, as shown in FIG. 4A, the storage means can comprise a groove 137 defined in an outer surface of the scissors and configured to receive and secure the guide member 150 to the scissors 131.

In still a further aspect, and with reference to FIG. 4A, the scissors 131 can comprise at least one sliding mechanism 138 secured medially along the longitudinal length of one of the first blade member 134 and the second blade member 136. In this aspect, and with reference to FIG. 4A, the sliding mechanism 138 can comprise a groove configured to slidingly engage the sliding member 132 of the handle 130. When the sliding member 132 is attached to the first lead portion and the second lead portion of a gingival retraction cord as described herein, it is contemplated that the handle can be slid within the groove (sliding mechanism 138) along at least a portion of the length of the scissors 131. It is contemplated that a dental practitioner can slide the sliding member 132 as needed to change the position of the gingival retraction cord 140.

As shown in FIGS. 5A-5D, gingival retraction system 200 comprises a gingival retraction cord 240 having at least one lead portion 242 and at least one retraction portion 244, as described with reference to FIGS. 2A-3 and the corresponding description. Gingival retraction system 200 further comprises a handle 230. The handle 230 comprises scissors 260, as described herein with respect to FIGS. 4A-4C and the corresponding description.

As shown in FIG. 5A, in one aspect, handle 230 can comprise an engagement portion 232 and a sliding member 236. It is contemplated that the engagement portion 232 of the handle 230 can be attached to the gingival retraction cord 240, as described herein with respect to handle 30 and gingival retraction cord 40. It is further contemplated that the engagement portion 232 can be selectively attached to the sliding member 236. For example and without limitation, the engagement portion 232 can be selectively mountable to the sliding member 236. In one exemplary aspect, the engagement portion 232 can define at least one bore 234, and the sliding member 236 can comprise at least one protrusion 238 that is configured for complementary insertion within the at least one bore of the engagement portion. In this aspect, it is contemplated that a dental practitioner can selectively mount the engagement portion 232 onto the at least one bore 234 of the sliding member 236. When the engagement portion 232 of the handle 230 is attached to the gingival retraction cord 240 as described herein, it is contemplated that the engagement portion of the handle can be mounted to the sliding member 236 such that the gingival retraction cord is operatively coupled to the sliding member.

In one aspect, and with reference to FIGS. 5B-5D, the scissors 260 can comprise a first blade member 264 and a second blade member 266 pivotally connected to the first blade member. In still a further aspect, the scissors 260 can comprise at least one sliding mechanism 268 secured medially along the longitudinal length of one of the first blade member 264 and the second blade member 266. In this aspect, and with reference to FIGS. 5B-5D, the sliding mechanism 268 can comprise a groove 269 configured to slidingly engage the sliding member 236 of the handle 130. When the sliding member 236 is coupled to the gingival retraction cord 240 as described herein, it is contemplated that the sliding member can be slid within the groove 269 of the sliding mechanism 268 along at least a portion of the length of the scissors 260. Accordingly, it is contemplated that a dental practitioner can slide the sliding member 236 as needed to change the position of the gingival retraction cord 240.

As shown in FIGS. 5B-5D, in another aspect, an inner blade member 266 of the scissors 260 can comprise at least one notched opening 261 defined in the inner blade member, and an outer blade member 264 can comprise at least one cutting opening 262 defined in the outer blade member. In this aspect, each notched opening 261 of the at least one notched opening can define a plurality of notches configured to receive one or more lead portions 242 of a gingival retraction cord 240 as described herein. It is further contemplated that each cutting opening 262 of the at least one cutting opening can comprise cutting means for cutting the gingival retraction cord 240 at desired locations. For example, as shown in FIG. 5D, the cutting means can comprise a blade surface 263 positioned within each cutting opening 262. In an additional aspect, each notched opening 261 of the at least one notched opening can be configured to overlap and align with a cutting opening 262 of the at least one cutting opening when the scissors 260 are in a closed position, as shown in FIG. 5C. As depicted in FIG. 5C, it is contemplated that, when the scissors 260 are in a closed position such that a cutting opening 262 is aligned with and overlapping a notched opening 261, the cutting means of the cutting opening can be in an opposed position relative to the notches of the notched opening such that the cutting means and the notches substantially face one another and are both visible by a user. It is further contemplated that, when the gingival retraction cord 240 is simultaneously positioned within the at least one notched opening 261 and the at least one cutting opening 262, the gingival retraction cord can be selectively cut by moving the scissors to an open position, as shown in FIG. 5B.

Optionally, the handle of the gingival retraction system can comprise at least one cord-packing mechanism. In one aspect, a portion of the at least one cord packing mechanism can be configured to contact a gingival retraction cord as described herein, thereby directing the gingival retraction cord therein the gingival sulcus.

In an additional aspect, the handle of the gingival retraction system can be re-useable. In this aspect, it is contemplated that the handle can further comprise means for quickly and securely attaching and removing the gingival retraction cord from the at least one attachment point on the handle, such as, for example and without limitation, a clamping mechanism, a quick-coupling mechanism, a latch mechanism, a button, a pin, a lock, a seam, and the like. Alternatively, at least a portion of the handle of the gingival retraction system can be disposable. In this aspect, it is contemplated that the handle can be discarded after a single use. It is further contemplated that the disposable handle can comprise hard plastic materials, cardboard, stiff paper, rubber, polymers, metals, ceramics, or other materials commonly known in the art that are substantially rigid and can be manufactured efficiently. In another aspect, at least a portion of the handle can be autoclavable. In an additional aspect, the handle can comprise a break-away portion than can be selectively removed following positioning of the gingival retraction cord therein the gingival sulcus. In a further aspect, the handle can have a means of shortening the at least one lead portion to approximate the handle to the retraction cord and the selected tooth.

Optionally, the handle can comprise an absorbent portion. In one aspect, the absorbent portion of the handle can be configured to reflect and retract the cheeks or tongue of a subject following placement of the gingival retraction cord as descried herein. In another aspect, the absorbent portion of the handle can be configured to absorb moisture within the mouth of the subject. It is contemplated that the absorbent portion of the handle can assist dental practitioners in accessing the area proximate the selected tooth.

In a further aspect, the handle can be mountably attachable to a dental instrument as is commonly known in the art, including, for example and without limitation, a drill. In this aspect, as one will appreciate, the gingival retraction system can be complementary to existing equipment that is commonly used by dental practitioners. In one aspect, the dental instrument can be coupled to a control mechanism. In this aspect, it is contemplated that the control mechanism can be an analog control mechanism. It is further contemplated that the control mechanism can be a digital control mechanism. It is still further contemplated that the dental instrument and control mechanism can be activated using any means commonly known in the art, including, without limitation, electrical means, magnetic means, mechanical means, and the like. In one aspect, the dental instrument and control mechanism can be activated using a mechanical spring. Alternatively, the dental instrument and control mechanism can be manually activated.

In an additional embodiment, the gingival retraction system can comprise a plurality of gingival retraction cords and at least one handle as described herein. In one aspect, the plurality of gingival retraction cords can comprise two gingival retraction cords. In this aspect, the at least one handle can comprise one handle, and the plurality of gingival retraction cords can be configured for attachment to the handle. It is contemplated that the attachment of the plurality of retraction cords to the handle can permit a dental practitioner to simultaneously and securely position more than one retraction cord within the gingival sulcus. In another aspect, one gingival retraction cord of the plurality of gingival retraction cords can be positioned on the lingual (tongue) side of the selected tooth, while another gingival retraction cord of the plurality of gingival retraction cords can be positioned on the buccal (cheek) side of the selected tooth. In an additional aspect, it is contemplated that the gingival retraction system can comprise a plurality of cutting means as described herein, including, for example and without limitation, a plurality of blades.

In another aspect, the at least one handle of the gingival retraction system can comprise a plurality of handles. In one aspect, the plurality of handles can comprise two handles. In this aspect, at least one gingival retraction cord of the plurality of gingival retraction cords can be configured for attachment thereto each handle of the plurality of handles.

In use, the gingival retraction system described herein can be provided to separate gingival tissue from around the selected tooth before a tooth preparation procedure. The lead portions of the gingival retraction cord can be raised or lowered in an apical direction within the mouth of the subject until each lead portion enters into and is positioned within a contact area defined by the selected tooth and an adjacent tooth. It is contemplated that movement of each lead portion in an apical direction can correspond to movement of each lead portion from a point proximate an occlusal surface (biting surface) of the selected tooth toward the gingival tissue surrounding the selected tooth. In one exemplary aspect, the at least one lead portion can be moved in the apical direction to substantially concurrently enter into both contact areas adjacent to the selected tooth. Thus, in this aspect, the entry of a first lead portion into a first contact area adjacent to the selected tooth can occur substantially concurrently with the entry of a second lead portion into a second contact area adjacent to the selected tooth.

As the lead portions approach the gingival tissue surrounding the selected tooth, the gingival retraction cord can be selectively moved as described herein until at least a portion of each retraction portion of the gingival retraction cord is positioned substantially around a desired portion of the perimeter of the selected tooth. For example, when the gingival retraction cord comprises a single retraction portion, it is contemplated that the retraction portion can be positioned substantially around about three-quarters of the perimeter of the selected tooth. It is contemplated that the gingival retraction cord can be selectively moved in any direction within the mouth of the subject as it is adapted to the selected tooth. For example, and without limitation, the gingival retraction cord can be moved away from the subject's tongue and toward the subject's cheeks. Alternatively, the gingival retraction cord can be moved away from the subject's cheeks and toward the subject's tongue.

In one aspect, the gingival retraction cord can be selectively moved as described herein until at least a portion of the retraction portion is positioned in an operative position around the perimeter of the selected tooth. In this aspect, the operative position can be a secure postion within the gingival sulcus around the perimeter of the selected tooth. In one aspect, it is contemplated that following the selective movement of the gingival retraction cord, at least about 10% of the length of the retraction portion of the gingival retraction cord can be positioned in the operative position. For example, and without limitation, it is contemplated that 10%, 20%, 30%, 40%, 50%, 60%, 70%, 80%, 90%, and percentages therebetween of the length of the retraction portion can be positioned in the operative position following the selective movement of the gingival retraction cord. Optionally, a dental instrument can be used to pack the retraction portion apically so as to retract gingival tissue and thereby position the retraction portion within the gingival sulcus. After the retraction portion is positioned within the gingival sulcus, the gingival retraction cord surrounding the selected tooth can be tightened and shortened. As one will appreciate, after the gingival retraction cord has been tightened and shortened, a desired portion of the perimeter of the selected tooth can be contacted by a portion of the gingival retraction cord. It is contemplated that the desired portion of the perimeter of the selected tooth can comprise substantially the entire perimeter of the selected tooth. The gingival retraction cord can be secured within the gingival sulcus around the perimeter of the selected tooth, and cutting means can be used to remove portions of the gingival retraction cord that are not required to secure the retraction portion within the gingival sulcus.

In one aspect, and with reference to FIGS. 8A and 8B, the cutting of the gingival retraction cord 340 by the cutting means can form a first end 342 and a second end 344 of the gingival retraction cord. In this aspect, as shown in FIG. 8A, it is contemplated that, following the cutting of the gingival retraction cord, the gingival retraction cord 340 can be positioned within the gingival sulcus surrounding the selected tooth 320 such that the space S between the first end 342 and the second end 344 of the gingival retraction cord is less than about 0.50 mm, more preferably less than about 0.25 mm, and most preferably less than about 0.10 mm. In another aspect, as shown in FIG. 8B, it is contemplated that, following the cutting of the gingival retraction cord 340, the gingival retraction cord can be positioned within the gingival sulcus surrounding the selected tooth 320 such that the first end 342 and the second end 344 of the gingival retraction cord overlap one another by a overlap length O. In this aspect, it is contemplated that the overlap length O can be less than about 0.25 mm, more preferably less than about 0.10 mm, and most preferably less than about 0.05 mm.

It is further contemplated that, following the cutting of the gingival retraction cord, the gingival retraction cord can be positioned within the gingival sulcus such that the remaining portions of the gingival retraction cord fit precisely within the gingival sulcus. Following the secure positioning of the gingival retraction cord within the gingival sulcus around the perimeter of the selected tooth, the tooth preparation procedure can be initiated.

It is contemplated that there can be some instances where portions of the margin of the selected tooth are prepared supragingival (above) the gingival sulcus. In these instances, the gingival retraction cord does not need to be packed into the sulcus in the areas proximate the supragingival portions of the margin. In one aspect, the gingival retraction system described herein permits dental practitioners to restrict subgingival (below the gingival tissue) placement of the gingival retraction cord to the areas where the margin is actually subgingival. After the gingival retraction cord is placed in this manner, the cutting means can be applied to cut the gingival retraction cord to form the first end and the second end of the gingival retraction cord. In these instances, it is contemplated that the space between the first end and the second end of the gingival retraction cord can be from about 1 mm to about 40 mm, depending upon the size of the portion of the margin that is supragingival.

In one aspect, the step of tightening and shortening the gingival retraction cord surrounding the selected tooth can comprise selectively moving the gingival retraction cord as described herein. For example, and without limitation, the step of tightening and shortening the gingival retraction cord can comprise rotating the gingival retraction cord, thereby twisting the gingival retraction cord onto itself.

In another aspect, the gingival retraction cord can be operatively coupled to at least one handle as described herein. In one aspect, each handle of the at least one handle can comprise a tightening mechanism as described herein, and the step of tightening and shortening the gingival retraction cord surrounding the selected tooth can comprise selectively using the tightening mechanism proximate the selected tooth. In an additional aspect, each handle of the at least one handle can comprise constricting means, and the step of tightening and shortening the gingival retraction cord surrounding the selected tooth can comprise squeezing together portions of the gingival retraction cord that are not positioned within the gingival sulcus. Optionally, each handle of the at least one handle can be configured for secure attachment to a cinching or cutting instrument. It is contemplated that the gingival retraction cord can be selectively attachable to the at least one handle. For example, and without limitation, the gingival retraction cord can be attached to the at least one handle immediately prior to a tooth preparation procedure.

Optionally, the handle can comprise cutting means as described herein, and the step of removing portions of the gingival retraction cord that are not required to secure the retraction portion within the gingival sulcus can comprise positioning the handle such that the gingival retraction cord comes into contact with the cutting means.

Optionally, the handle can comprise at least one cord-packing mechanism, and the step of selectively moving the gingival retraction cord can comprise packing the gingival retraction cord within the gingival sulcus with the at least one cord-packing mechanism.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A gingival retraction system for retracting gingival tissue proximate a selected tooth within the mouth of a subject prior to a tooth preparation procedure, the gingival retraction system comprising:
a gingival retraction cord comprising:
at least one lead portion configured for movement in an apical direction to enter into a contact area defined by the selected tooth and an adjacent tooth within the mouth of the subject; and
at least one retraction portion configured for insertion within the gingival sulcus surrounding at least a portion of the selected tooth, wherein the at least one retraction portion is attached to the at least one lead portion; and
a handle configured for attachment to the gingival retraction cord at least one attachment point,
wherein, upon attachment of the gingival retraction cord to the handle, the handle is selectively moveable by a dental practitioner within the mouth of the subject such that the at least one retraction portion of the gingival retraction cord is securely positioned within at least a portion of the gingival sulcus surrounding the selected tooth.

2. The gingival retraction system of claim 1, wherein the at least one lead portion of the gingival retraction cord comprises a first lead portion and a second lead portion, wherein the at least one retraction portion comprises a retraction portion, and wherein the retraction portion of the gingival retraction cord is attached to and positioned between the first lead portion and the second lead portion.

3. The gingival retraction system of claim 2, wherein the first lead portion is attached to the second lead portion such that a loop of continuous material is formed.

4. The gingival retraction system of claim 2, wherein the first lead portion defines a loop for receiving at least a portion of the second lead portion.

5. The gingival retraction system of claim 4, wherein the second lead portion comprises a substantially rigid portion.

6. The gingival retraction system of claim 2, wherein the first lead portion is attached to the handle at a first attachment point, wherein the second lead portion is attached to the handle at a second attachment point, and wherein the first attachment point is spaced from the second attachment point by a selectively adjustable distance.

7. The gingival retraction system of claim 1, wherein the at least one lead portion of the gingival retraction cord comprises a first lead portion, a second lead portion, and a retraction portion, wherein the retraction portion of the gingival retraction cord has a central bore defined along a longitudinal axis of the retraction portion, and wherein the first lead portion and the second lead portion are constructed of a unitary piece of material configured for passage through the central bore of the retraction portion.

8. The gingival retraction system of claim 1, wherein the lead portions and the retraction portions of the gingival retraction cord are secured to one another in an alternating fashion such that the retraction portions are positioned between successive lead portions.

9. The gingival retraction system of claim 1, wherein the at least one lead portion of the gingival retraction cord comprises a substantially rigid portion.

10. The gingival retraction system of claim 1, wherein the cross-sectional thickness of each lead portion of the gingival retraction cord ranges from about 0.01 mm to about 0.20 mm.

11. The gingival retraction system of claim 1, wherein the cross-sectional thickness of each retraction portion of the gingival retraction cord ranges from about 0.20 mm to about 3.00 mm.

12. The gingival retraction system of claim 1, wherein each retraction portion of the gingival retraction cord is impregnated with a retraction agent selected from the group consisting of a clotting agent, a drying agent, a hemostatic agent, and a topical anesthetic.

13. The gingival retraction system of claim 1, wherein the handle is selectively moveable by the dental practitioner within the mouth of the subject such that the gingival retraction cord is twisted onto itself to tighten the cord around the selected tooth.

14. The gingival retraction system of claim 1, wherein the handle comprises a tightening mechanism for moving the gingival retraction cord in one or more directions to selectively control the length of the at least one retraction portion that is positioned within the gingival sulcus surrounding the selected tooth.

15. The gingival retraction system of claim 1, wherein the handle comprises a cutting means configured to trim portions of the gingival retraction cord.

16. The gingival retraction system of claim 1, wherein the handle comprises scissors having a first blade member pivotally connected to a second blade member, wherein the first blade member and the second blade member are configured to cut the gingival retraction cord.

17. The gingival retraction system of claim 16, wherein the scissors further comprise a guide member detachably secured to the first blade member, wherein the guide member has a plurality of notches configured to receive and secure the gingival retraction cord in a desired position prior to cutting of the gingival retraction cord by the first blade member and the second blade member.

18. The gingival retraction system of claim 17, wherein the first blade member comprises a grooved portion configured to receive a portion of the guide member such that the guide member is secured in an operative position prior to cutting of the gingival retraction cord by the first blade member and the second blade member.

19. The gingival retraction system of claim 16, wherein the first blade member comprises a sliding mechanism secured medially along a longitudinal length of the first blade member, wherein the handle further comprises a sliding member and an engagement portion attached to the gingival retraction cord, wherein the engagement portion is configured for selective attachment to the sliding member, and wherein the sliding mechanism comprises a groove configured to slidingly engage the sliding member of the handle.

20. The gingival retraction system of claim 19, wherein the second blade member comprises at least one notched opening defined by the second blade member, wherein the first blade member comprises at least one cutting opening defined by the first blade member, wherein each notched opening is configured to receive a lead portion of the gingival retraction cord, wherein each cutting opening comprises cutting means for cutting the gingival retraction cord at desired locations, and wherein each notched opening of the at least one notched opening is configured to overlap and align with a cutting opening of the at least one cutting opening when the scissors are in a closed position.

21. The gingival retraction system of claim 1, wherein the handle is reusable.

22. A gingival retraction system for retracting gingival tissue proximate a selected tooth within the mouth of a subject prior to a tooth preparation procedure, the gingival retraction system comprising:
at least one gingival retraction cord, each gingival retraction cord of the at least one gingival retraction cord comprising:
at least one lead portion configured for movement in an apical direction to enter into a contact area defined by the selected tooth and an adjacent tooth within the mouth of the subject; and
a retraction portion configured for insertion within the gingival sulcus surrounding at least a portion of the selected tooth, wherein the retraction portion is attached to the at least one lead portion; and
at least one handle, each handle being configured for attachment to a gingival retraction cord of the at least one gingival retraction cord at least one attachment point,
wherein, upon attachment of the at least one gingival retraction cord to the at least one handle, each handle is selectively moveable by a dental practitioner within the mouth of the subject such that the at least one retraction portion of each gingival retraction cord is securely positioned within at least a portion of the gingival sulcus surrounding the selected tooth.

23. A method for retracting gingival tissue proximate a selected tooth within the mouth of a subject prior to a tooth preparation procedure using a gingival retraction cord and a handle, the selected tooth having a perimeter, the gingival retraction cord having at least one lead portion and at least one retraction portion attached to the at least one lead portion, the method comprising:
attaching the gingival retraction cord to the handle at least one attachment point;
moving the at least one lead portion in an apical direction such that each lead portion enters into and is positioned within a contact area defined by the selected tooth and an adjacent tooth within the mouth of the subject;
selectively moving the handle within the mouth of the subject such that at least a portion of the at least one retraction portion of the gingival retraction cord is securely positioned within the gingival sulcus surrounding the selected tooth; and
cutting selected portions of the gingival retraction cord positioned outside of the gingival sulcus surrounding the selected tooth.

24. The method of claim 23, wherein the step of cutting selected portions of the gingival retraction cord comprises forming a first end and a second end of the gingival retraction cord, and wherein, following the cutting of the gingival retraction cord, the gingival retraction cord is positioned within the gingival sulcus such that the space between the first end and the second end of the gingival retraction cord is less than about 0.50 mm.

25. The method of claim 23, wherein the step of cutting selected portions of the gingival retraction cord comprises forming a first end and a second end of the gingival retraction cord, and wherein, following the cutting of the gingival retraction cord, the gingival retraction cord is positioned within the gingival sulcus such that first end and the second end of the gingival retraction cord overlap one another by less than about 0.25 mm.
